(19) United States
(12) Patent Application Publication
(10) Pub. No.: US 2009/0091436 A1
(43) Pub. Date: Apr. 9, 2009

(54) ELECTRONIC TOWING BALL VIEWER

(76) Inventor: LEROY E. ANDERSON, BOISE, ID (US)

Correspondence Address: DYKAS, SHAVER & NIPPER, LLP, P.O. BOX 877, BOISE, ID, 83701-0877, US

(21) Appl. No.: 12/245,909

(22) Filed: Oct. 6, 2008

Related U.S. Application Data
(60) Provisional application No. 60/977,790, filed on Oct. 5, 2007.

(51) Int. Cl. B60Q 1/00; G06F 3/041; H04N 5/262; H04N 7/18

(52) U.S. Cl. 340/435; 345/173; 348/240.99; 348/148; 348/E05.051; 348/E07.085

(57) ABSTRACT

An electronic towing ball viewer for placement near a towing ball on the exterior of a vehicle, so that a person backing a towing vehicle toward a trailer hitch may see the ball as it approaches the trailer hitch. The unit includes a zoom function which zooms to the lower center, to the right, left, lower left, or lower right of the screen in order to give the user a view of those regions in order to better see a tow ball and trailer hitch.

### CROSS-REFERENCE TO RELATED APPLICATIONS

This application claims the priority date of the provisional application entitled ELECTRONIC VIEWER filed by Leroy E. Anderson on Oct. 5, 2007 with application Ser. No. 60/977,790.

### FIELD OF THE INVENTION

The invention generally relates to an apparatus for viewing items at the rear of a vehicle, and more particularly to a digital device for viewing the towing hitch of a vehicle.

### BACKGROUND OF THE INVENTION

Trailers and equipment attached to the rear of a towing vehicle are coupled to the vehicle by various types of connections, with a towing ball inter-fitting with a trailer hitch on a trailer tongue being a common system. In order to connect the towing vehicle to the vehicle being towed, the towing vehicle is backed into position so that the towing ball is directly under the hitch of the towed vehicle. Towing vehicles can be trucks or automobiles, and it is difficult for the driver to accurately back up the towed vehicle so that it is perfectly in position under the trailer hitch. Due to difficulty in accurately backing to this position this job is often a two man job, with a spotter giving directions to the driver on how to maneuver the towing vehicle into position.

Solving this problem is sometime attempted by the use of mirrors, but these are problematic and do not really solve the problem. Accordingly, what is needed is a device for viewing the towing ball of a vehicle as the towing vehicle approaches a trailer hitch to allow for one man connection of a trailer hitch to a towing ball.

### SUMMARY OF THE INVENTION

The invention is an electronic towing ball viewer, which is mounted to a vehicle in a position so that it can view the towing ball of the vehicle as the vehicle is backed towards a vehicle to be towed. It includes a digital camera lens unit which is mounted adjacent to the towing ball. The towing ball can be on the rear of a vehicle or on the front of a vehicle.

The device also includes a digital viewing screen unit with a view screen for mounting inside the vehicle. The digital viewing screen unit is operationally connected to a digital camera lens unit for convenient viewing of the towing ball of the vehicle. The operational connection may be by conventional wires or it may be by a wireless connection using any number of wireless formats.

### BRIEF DESCRIPTION OF THE DRAWINGS

FIG. 1 is a view of the electronic tow ball viewer of the invention positioned adjacent to a towing ball.

FIG. 2 is a side view showing the digital camera lens unit viewing a towing ball.

FIG. 3 is a top view of the digital camera lens unit adjacent a towing ball.

FIG. 4 is a front view of the digital viewing screen unit mounted on a dash board.

### DESCRIPTION OF THE PREFERRED EMBODIMENTS

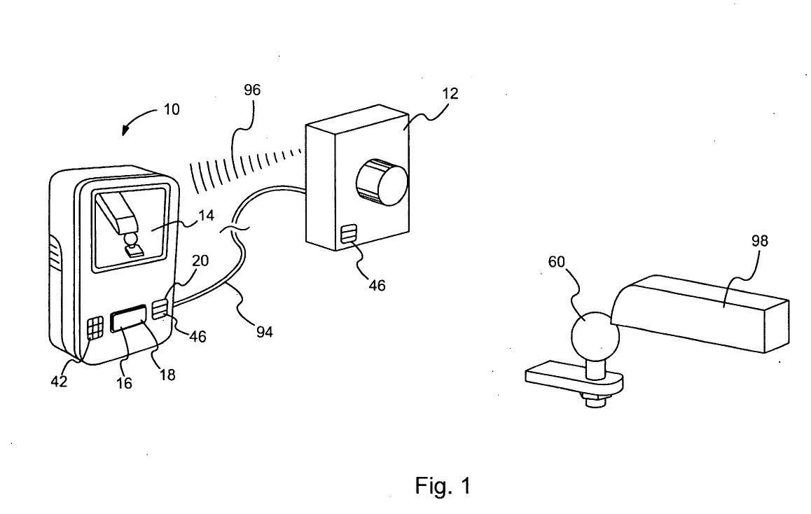

The electronic towing ball viewer of the invention is shown in FIGS. 1 through 4. FIG. 1 shows a towing ball 60 and a trailer hitch 98. The towing ball 60 will typically be mounted on the rear bumper of a vehicle, but could also be mounted on the front bumper of a vehicle. Shown in FIG. 1 is a digital camera lens 12 and a digital viewing screen 14. The digital view screen 14 includes a zoom point selector pad 42 by which the user specifies which portion of the screen to zoom in on. It also includes an off center zoom feature 16 and an off center zoom feature activation button. After selecting the portion of the view screen to zoom in on using the zoom point selection pad 42, pressing the off center activation button 18 causes the image to zoom in on the selected portion of the image. The device shown in FIG. 1 includes a speaker/microphone 46 in both the digital viewing screen unit and the digital camera lens unit 14 and 12. This is so that a spotter, if one is present, and the driver of the towing vehicle can converse using the device of the invention.

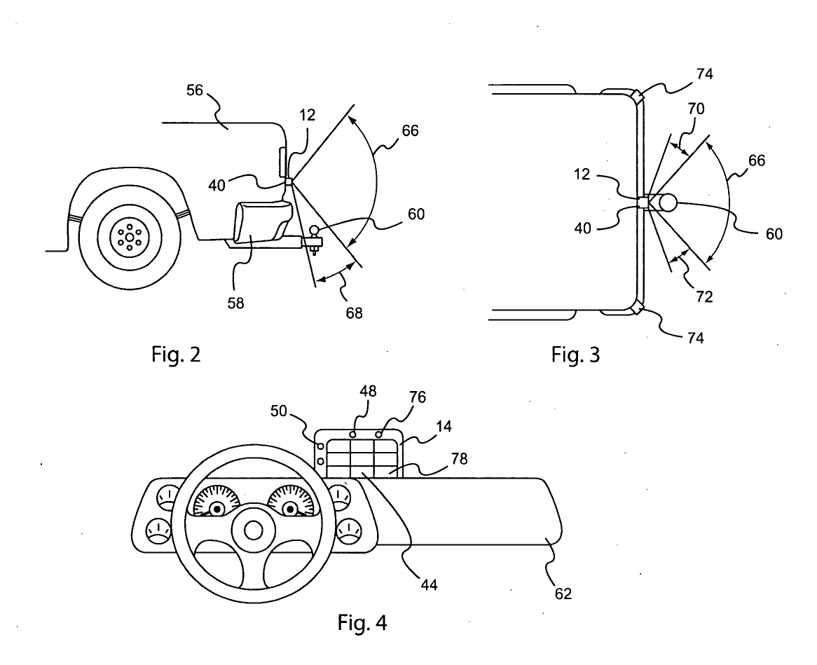

FIG. 2 is a side view of a typical towing arrangement showing the towing ball 60 mounted adjacent the bumper 58 of the automobile 56. The digital camera lens unit 12 is positioned near the bumper 58 of the vehicle and includes a light source 40 for illuminating the towing ball in low light situations. The default range of the camera is shown in the angle designated 66. This particular range of camera would be useful to identify the position of the trailer hitch as the towing vehicle approached the trailer hitch. As the trailer hitch approached a position directly over the ball 60 the driver of the vehicle could utilize the off center zoom feature to change the angle of the camera toward a downward viewing angle which is shown as 68. Using this viewing angle the towing ball 60 can be positioned perfectly under the trailer hitch.

FIG. 3 shows the digital camera lens unit 12 with a light source 40 mounted adjacent to an above towing ball 60. The default range of the camera is shown as 66, with a range 70 showing what a camera would see if it zoomed to the left, and a range 72 showing what a camera would see if it zoomed to the right. Also shown are auxiliary camera 74 which may be utilized with the system in order to allow views to the side of the automobile.

The electronic viewer of the invention is shown in FIGS. 1-9. FIG. 1 shows an exploded view of the electronic viewer of the invention. Shown is the digital viewing screen 14, the digital camera lens 12, the display cover 22, the battery box 26, and batteries 28.

The electronic viewer 10 of the invention further includes a speaker/microphone 46 which is shown in FIG. 2.

FIG. 3 is a perspective view of the electronic viewer 10 of the invention in which the pieces are assembled and the view screen 14 is visible.

FIG. 6 shows a cross-sectional view of the electronic viewer 10 of the invention mounted in a door 32. The door 32 would either be drilled to have a hole through the door, or an existing peephole viewer would be removed from the door, leaving a hole for installation of the electronic viewer 10 of the invention. FIG. 6 shows the electronic viewer 10 of the invention with the digital viewing screen 14 mounted on one side of the door and the digital camera lens 12, mounted on the other side of the door. In the example shown in FIG. 6, the camera and the view screen are connected by wiring and may be placed inside a door tube 30 as part of the installation kit. The device can also be installed on a door in which there is no pre-existing peephole viewer hole, and the digital camera lens 12 is mounted on one side of the door, and is in communication with the viewing screen 14 using any one of a number of available wireless technologies.

The electronic viewer 10 of the invention also has the capability of zooming in on an object with a zoom feature which zooms to an off-center region of the screen. It is common in the prior art for an electronic viewing device to zoom straight forward and to magnify the portion of the screen which is in the center of the screen. This is generally a workable practice in Items such as cameras. However, in a viewer which is utilized in a door situation, it is more advantageous to zoom to an area that is not in the center of the view screen. This requires the use of a zoom point selection pad which can be in the form of a pad of buttons shown in Figure 4, or can be in the form of a touch screen zoom selection such as shown in FIG. 44. By choosing the area to zoom towards, the view screen zooms, for instance, to the lower bottom of the screen, the lower left or right, the right side of the screen, the left side of the screen, or the center left or right upper part of the screen.

FIG. 4 shows an image of a person in the lower center of the view screen 14. When a selection is made on the zoom point selection pad 42 to zoom to the lower center of the screen, the view changes to that shown in FIG. 5. Shown in FIG. 4 is a view button 24 which activates the unit and a zoom button 16 which controls the amount of magnification of the image.

FIG. 5 also shows a magnification button 50, and a brightness button 48. The brightness button 48 can be tapped to

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An electronic towing ball viewer, for viewing a towing ball mounted to a vehicle, comprising:
a digital camera lens unit for mounting in a position adjacent to a towing ball mounted on a vehicle;
a digital viewing screen unit with a view screen, for mounting in said vehicle, with said digital viewing screen unit operationally connected to said digital camera lens, for convenient viewing of said towing ball of said vehicle;
an off center zoom feature in which a selected region shown in said view screen is magnified, in which the region magnified is a region other than the center of the image of said region to be viewed;
an off center zoom activation button; wherein
said viewing screen is configured to enlarge an off center portion of an image viewed in the view screen when said off center zoom activation button is depressed, with said image magnified to show greater detail of a part of the image which is not the center of the image displayed.

2. The electronic towing ball viewer of claim 1 in which said zoom feature is configured to magnify a region of said image located in the lower center of said image.

3. The electronic towing ball viewer of claim 1 in which said zoom feature is based on software magnification of said image.

4. The electronic towing ball viewer of claim 1 in which said zoom feature is configured to magnify a region of said image located in the lower right of said image.

5. The electronic towing ball viewer of claim 1 in which said zoom feature is configured to magnify a region of said image located in the lower left of said image.

6. The electronic towing ball viewer of claim 1 in which said zoom feature is configured to magnify one of a plurality of regions of said image, in which the region to be magnified is not the center of the image.

7. The electronic towing ball viewer of claim 6 in which said electronic viewer further comprises a zone selection button, for selecting a region of said image to magnify.

8. The electronic towing ball viewer of claim 6 in which said electronic viewer further comprises a zone selection button in the form of a touch screen, for selecting a region of said image to magnify.

9. The electronic towing ball viewer of claim 1 in which digital camera lens' said zoom feature is configured to magnify one of a plurality of regions of said image, in which the region to be magnified is not the center of the image.

10. The electronic towing ball viewer of claim 7 which further comprises a magnification button to change magnification to different levels of magnification.

11. The electronic towing ball viewer of claim 7 which further comprises a brightness button to change brightness of said image to different levels of brightness.

12. The electronic towing ball viewer of claim 1 in which said digital camera lens unit is configured for mounting on a rear of a vehicle, with said digital viewing screen unit configured for placement on a dashboard of said vehicle.

13. The electronic towing ball viewer of claim 1 which further includes a voice transmittal unit in both said digital camera lens unit and said digital viewing screen unit, for voice communication between said units.

14. The electronic towing ball viewer of claim 12 in which said electronic viewer is configured for mounting in a license plate holder attached to said vehicle.

15. The electronic towing ball viewer of claim 12 which further includes a light source in said digital camera lens unit for illuminating said towing ball.

16. The electronic towing ball viewer of claim 12 which further includes a plurality of cameras placed at various locations around a vehicle, with said view screen further comprising a camera selection button to select which camera to display an image from on said view screen.

17. The electronic towing ball viewer of claim 16 which further comprises a selection means to select a region on each image of each camera for viewing, and a magnification means for magnification of the selected region of the selected image.

18. The electronic towing ball viewer of claim 17 which further comprises a magnification selection means for selecting different levels of magnification for the image selected from the various cameras.

19. The electronic towing ball viewer of claim 18, which further includes a proximity sensor for triggering an alarm when an object behind the vehicle is within a specified distance of the digital camera lens unit.
